(19) United States
(12) Patent Application Publication
(10) Pub. No.: US 2022/0067214 A1
(43) Pub. Date: Mar. 3, 2022

(54) DELETING CONTENT FROM TEMPORARY MEMORY

(71) Applicant: International Business Machines Corporation, Armonk, NY (US)

(72) Inventors: Tanner Mark Preiss, Schnecksville, PA (US); Craig M. Trim, Ventura, CA (US); Jeremy R. Fox, Georgetown, TX (US); Fang Lu, Billerica, MA (US); Uri Kartoun, Cambridge, MA (US)

(21) Appl. No.: 17/002,812

(22) Filed: Aug. 26, 2020

(51) Int. Cl. G06F 21/78; G06F 21/88; G06F 21/62; G06F 9/54; G06N 20/00

(52) U.S. Cl. CPC G06F 21/78; G06F 21/88; G06N 20/00; G06F 9/543; G06F 21/6245

(57) ABSTRACT

An indication of a user saving a content to a clipboard of a computing device is received. Based on analysis of the saved content and a context of the actions being performed by the user, a determination is made whether the saved content is a password. In response to determining that the saved content is a password, at least one delete action from a group of delete actions is executed.

### BACKGROUND

The present invention relates generally to the field copying and pasting data to a computer clipboard, and more particularly to providing for the deletion of content from a computer clipboard.

Computer users often use shortcuts to improve the usability of their computers. One of the popular shortcuts is the “copy/paste” shortcut (e.g., CTRL-C or COMMAND-C for copy and CTRL-V or COMMAND-V for paste). This shortcut allows users to easily copy content from one location and to paste it in one or more other locations for use in said one or more other locations. With the large number of passwords users have today for accessing their computers as well as various applications and websites, one common use of the “copy/paste” shortcut is to copy a password from a stored file and pasting the copied password into an application or website to gain access to the application or website. This prevents the user from having to memorize a large number of complex and lengthy passwords.

### SUMMARY OF THE INVENTION

Embodiments of the present invention include an approach for providing for the deletion of content from a computer clipboard. In one embodiment, an indication of a user saving a content to a clipboard of a computing device is received. Based on analysis of the saved content and a context of the actions being performed by the user, a determination is made whether the saved content is a password. In response to determining that the saved content is a password, at least one delete action from a group of delete actions is executed.

### BRIEF DESCRIPTION OF THE DRAWINGS

FIG. 1 depicts a functional block diagram of a computing environment, in accordance with an embodiment of the present invention;

FIG. 2 depicts a flowchart of a program providing for the deletion of content from a computer clipboard, in accordance with an embodiment of the present invention; and

FIG. 3 depicts a block diagram of components of the computing environment of FIG. 1, in accordance with an embodiment of the present invention.

### DETAILED DESCRIPTION

Embodiments of the present invention recognize that the use of the copy/paste shortcut by computer users is widespread because of the speed and ease of using the shortcut. Often the use of copy/paste is innocuous, for example, copying a joke or funny picture by a computer user to send to another user. And sometimes, the use can seem innocuous but may not be. Consider a computer user copying a password used to access a bank account owned by the computer user. After the user pastes the copied password and gains access to the bank account, the copied password sits in the computer clipboard memory, subject to potential hacking by a malicious computer user.

Embodiments of the present invention recognize that there may be a method, computer program product, and computer system for providing for the deletion of content from a computer clipboard. In an embodiment, the method, computer program product, and computer system receives an indication of a content copied to a computer clipboard by a computer user. The method analyzes the content, as well as the context of the user, to determine if the content is a password. In response to determining that the content is a password, the content is deleted from the clipboard after a paste action by the user.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention will now be described in detail with reference to the Figures.

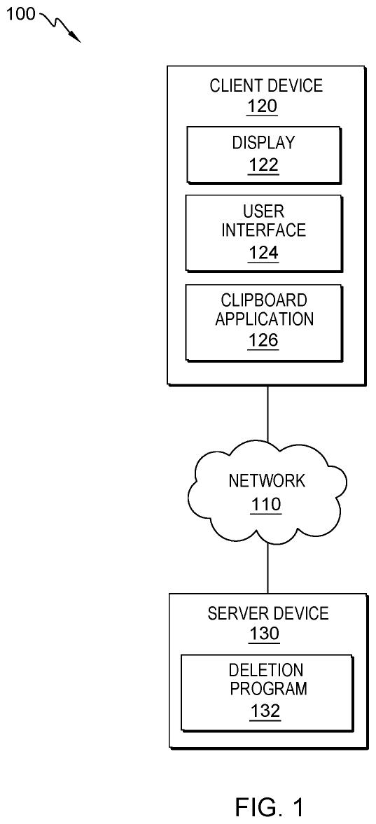

FIG. 1 is a functional block diagram illustrating a computing environment, generally designated 100, in accordance with one embodiment of the present invention. FIG. 1 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

In an embodiment, computing environment 100 includes client device 120 and server device 130, interconnected by network 110. In example embodiments, computing environment 100 includes other computing devices (not shown in FIG. 1) such as smartwatches, cell phones, additional smartphones, wearable technology, phablets, tablet computers, additional laptop computers, additional desktop computers, other computer servers or any other computer system known in the art, interconnected with client device 120 and server device 130 over network 110

In embodiments of the present invention, client device 120 and server device 130 are connected to network 110, which enables client device 120 and server device 130 to access other computing devices and/or data not directly stored on client device 120 and server device 130. Network 110 may be, for example, a short-range, low power wireless connection, a local area network (LAN), a telecommunications network, a wide area network (WAN) such as the Internet, or any combination of the four, and include wired, wireless, or fiber optic connections. In an embodiment, network 110 includes one or more wired and/or wireless networks that are capable of receiving and transmitting data, voice, and/or video signals, including multimedia signals that include voice, data, and video information. In general, network 110 is any combination of connections and protocols that will support communications between client device 120 and server device 130, and any other computing devices (not shown in FIG. 1) connected to network 110, in accordance with embodiments of the present invention. In an embodiment, data received by another computing device (not shown in FIG. 1) in computing environment 100 is communicated to client device 120 and server device 130 via network 110.

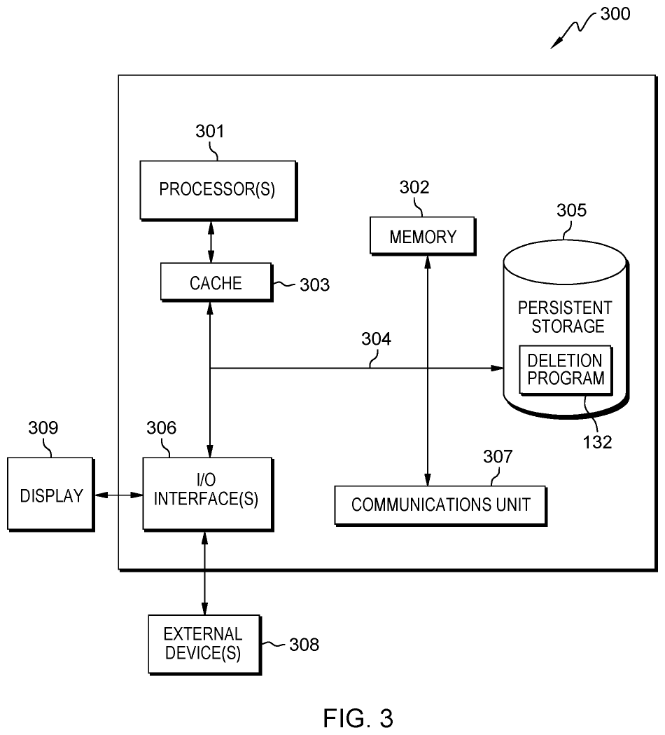

In an embodiment, client device 120 is one of a laptop, tablet, or netbook personal computer (PC), a desktop computer, a personal digital assistant (PDA), a smartphone, a standard cell phone, a smartwatch or any other wearable technology, or any other hand-held, programmable electronic device capable of communicating with any other computing device within computing environment 100. According to embodiments, client device 120 can be a standalone computing device, a management server, a web server, a mobile computing device, or any other electronic device or computing system capable of receiving, transmitting, and processing data. In other embodiments, client device 120 can represent computing systems utilizing multiple computers as a server system, such as in a cloud computing environment. In certain embodiments, client device 120 represents a computer system utilizing clustered computers and components (e.g., database server computers, application server computers, etc.) that act as a single pool of seamless resources when accessed by elements of computing environment 100. In general, client device 120 is representative of any electronic device or combination of electronic devices capable of executing computer readable program instructions. In an embodiment, computing environment 100 includes any number of client device 120. Client device 120 may include internal and external hardware components as depicted and described in further detail with respect to FIG. 3, in accordance with embodiments of the present invention. In an embodiment, client device 120 includes display 122, user interface 124, and clipboard application 126.

According to embodiments of the present invention, display 122 is an electronic visual device for a desktop computer, laptop computer, tablet computer, smartphone, smartwatch, and the like. Display 122 may include a touchscreen which is an input device layered on top of the display for allowing a user to control an electronic device via simple or multi-touch gestures by touching display 122 with a special stylus and/or one or more fingers. Display 122 displays open programs and applications, allowing a user of client device 120-N to interact with the open programs and applications via a keyboard, mouse, and buttons (not shown in FIG. 1). Display 122 may be a thin film transistor liquid crystal display (TFT-LCD), a flat panel LED (light emitting diode) display, a cathode ray tube (CRT), or any type of display device known in the art or developed in the future. Display 122 may be connected to client device 120 via VGA (video graphics array), DVI (digital video interface), HDMI (High Definition Multi-Media Interface), or any other connection type known in the art or developed in the future.

In an embodiment, user interface 124 provides an interface between a user of client device 120 and clipboard application 126. User interface 124 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. User interface 124 may also be mobile application software that provides an interface between client device 120 and clipboard application 126. Mobile application software, or an “app,” is a computer program designed to run on smartphones, tablet computers and other mobile devices. User interface 124 enables a user of client device 120 to interact with clipboard application 126, server device 130, and any other computing devices not shown in FIG. 1.

According to one embodiment, clipboard application 126 is a software program or group of programs designed for end users for providing a temporary, easy to access storage for the end users. A popular use of clipboard application 126 is to copy a content from a first location to the temporary memory followed by pasting the copied content to a second location. For example, a user can copy a password from a file location and then paste the password into an application to gain access to the application. Clipboard application 126 may be bundled with the client device 120 and its system software or published separately, and may be coded as proprietary, open-source, or a university project. Software application, such as clipboard application 126 that are built for mobile platforms are called mobile apps. In an embodiment, clipboard application 126 allows for a user temporarily store content for use.

In an embodiment, server device 130 may be one of a laptop, tablet, or netbook personal computer (PC), a desktop computer, a personal digital assistant (PDA), a smartphone, a standard cell phone, a smartwatch or any other wearable technology, or any other hand-held, programmable electronic device capable of communicating with any other computing device within computing environment 100. According to embodiments, server device 130 can be a standalone computing device, a management server, a web server, a mobile computing device, or any other electronic device or computing system capable of receiving, transmitting, and processing data. In other embodiments, server device 130 can represent computing systems utilizing multiple computers as a server system, such as in a cloud computing environment. In certain embodiments, server device 130 represents a computer system utilizing clustered computers and components (e.g., database server computers, application server computers, etc.) that act as a single pool of seamless resources when accessed by elements of computing environment 100. In general, server device 130 is representative of any electronic device or combination of electronic devices capable of executing computer readable program instructions. In an embodiment, computing environment 100 includes any number of server device 130. Server device 130 may include internal and external hardware components as depicted and described in further detail with respect to FIG. 3, in accordance with embodiments of the present invention. According to an embodiment of the present invention, server device 130 supports clipboard application 126 via deletion program 132 which is stored to server device 130.

According to an embodiment of the present invention, deletion program 132 can be a program, a subprogram of a larger program, an application, a plurality of applications, or mobile application software, which functions to provide for the deletion of content from a computer clipboard. A program is a sequence of instructions written to perform a specific task. In an embodiment, deletion program 132 runs by itself. In other embodiments, deletion program 132 depends on system software (not shown in FIG. 1) to execute. In one embodiment, deletion program 132 functions as a stand-alone program residing on server device 130. In another embodiment, deletion program 132 works in conjunction with other programs, applications, etc., found in computing environment 100. In yet another embodiment, deletion program 132 resides on any computing device within computing environment 100, for example, client device 120. In yet another embodiment, deletion program 132 resides on other computing devices (not shown in FIG. 1) in computing environment 100, which are interconnected to server device 130 via network 110.

According to an embodiment, deletion program 132 receives an acknowledgement of a user opting in to use of deletion program 132. In the embodiment, deletion program 132 analyzes the activity and interactions of a computer user. Further in the embodiment, deletion program 132 receives an indication of the user saving content to the computer clipboard. Further yet in the embodiment, deletion program 132 analyzes the content of the clipboard and the context of the computer user. Further yet in the embodiment, deletion program 132 determines whether the content is a password. Further yet in the embodiment, responsive to determining that the content is a password, deletion program 132 executes at least one of several deletion actions for deleting the content from the computer clipboard.

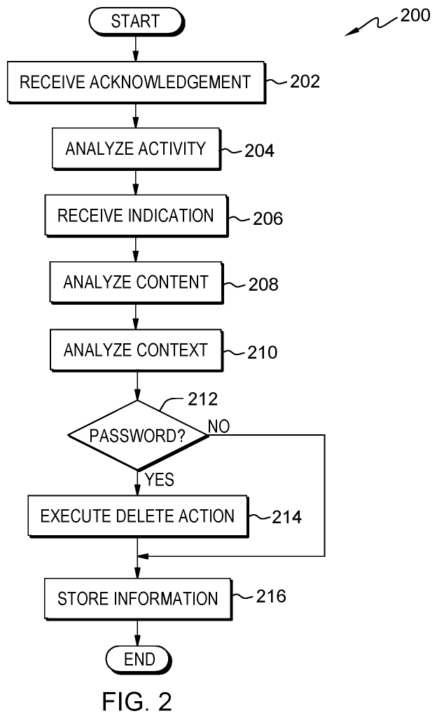

FIG. 2 is a flowchart of workflow 200 depicting a method for providing for the deletion of content from a computer clipboard. In one embodiment, the method of workflow 200 is performed by deletion program 132. In an alternative embodiment, the method of workflow 200 is performed by any other program working with deletion program 132. In an embodiment, a user of client device 120 invokes workflow 200 upon copying content to a computer clipboard. In an alternative embodiment, a user of client device 120 invokes workflow 200 upon accepting an opt in for deletion program 132.

In an embodiment, deletion program 132 receives acknowledgement (step 202). In other words, deletion program 132 receives an acknowledgement of a user. In one embodiment, the acknowledgement includes an indication of the user opt in for the use of deletion program 132. In another embodiment, the acknowledgement includes an indication of the awareness of the user that deletion program 132 is active on the computing device of the user. According to an embodiment of the present invention, deletion program 132 receives acknowledgement over network 110 from a user of client device 120 and the acknowledgement is an opt in of the user to use deletion program 132. For example, a program on a laptop used by Emily receives an acknowledgement from Emily indicating an opt in to use a clipboard deletion program.

According to an embodiment of the present invention, deletion program 132 analyzes activity (step 204). In other words, deletion program 132 analyzes the computer use of a user to determine patterns of the user such as when the user logs into a specific application or program which requires a password for access. In an embodiment, deletion program 132 analyzes the activities and interactions of the user as the user utilizes the computer. In the embodiment, activities include actions like using a word processing program or a spreadsheet and interactions include logging into social media and accessing a bank account. Further in the embodiment, deletion program 132 analyzes days and times of the various activities and interactions to further refine the patterns of the user. According to an embodiment, deletion program 132 analyzes the activity of the user of client device 120. For example, the program on the laptop used by Emily analyzes the computer use of Emily and determines that Emily turns on the laptop daily at 7:30 AM and uses an e-mail application amongst other work-related programs. Via the analysis, the program also determines that Emily accesses a bank account daily at 12:00 PM to check the account balances of several retirement investments.

In an embodiment, deletion program 132 receives an indication (step 206). In other words, deletion program 132 receives an indication of a user saving content to a clipboard memory of a computing device. According to an embodiment, the clipboard is a certain area of the random access memory (RAM) of the computer where copied data is temporarily stored. A user, via copy and paste commands, can store content to the clipboard from a first location and paste the stored content to a second location. In the embodiment, if a first content is stored to the clipboard, said first content is deleted from the clipboard when a new, second content is stored to the clipboard. According to an embodiment, deletion program 132 receives the indication of a user saving content to the clipboard when the user utilizes the “copy” command (e.g. CTRL-C or COMMAND-C). According to another embodiment, deletion program 132 receives the indication when stored content is deleted from the clipboard. In an embodiment, deletion program 132 receives an indication over network 110 of a user of client device 120 storing content via clipboard application 126, to the clipboard of client device 120. For example, the program on the laptop used by Emily receives an indication of Emily using the CTRL-C command to copy the password used to access the bank account for her retirement accounts. In the example, the copied password is “6x9t4W7*m#5v2@lycDleP#9h$0oO@vz”, which Emily considers too difficult to remember.

According to an embodiment of the present invention, deletion program 132 analyzes content (step 208). In other words, responsive to receiving an indication of content being copied to the clipboard, deletion program 132 analyzes said content to determine the type of content the user saved to the clipboard. In an embodiment, deletion program 132 analyzes the content to determine the type of content. In the embodiment, types of content include, but are not limited to: (i) an existing word or words, (ii) part of or a complete sentence, (iii) website uniform resource locator (URL), (iv) a picture, and (v) a random string of characters of varying length which can include words in a dictionary and words not in a dictionary which together form a password and meet standard password requirements. According to an embodiment, deletion program 132 utilizes machine learning (ML), natural language processing (NLP), and natural language classification (NLC), amongst other technologies known in the art, to analyze the content. In the embodiment, ML is the scientific study of algorithms and statistical models that computer systems use to perform a specific task without using explicit instructions, relying on patterns and inference instead. ML algorithms build a mathematical model based on sample data, known as “training data”, in order to make predictions or decisions without being explicitly programmed to perform the task. ML is seen as a subset of artificial intelligence (AI). In an embodiment, each time the user pastes content from the clipboard to a location as part of accessing an application or a program, deletion program 132 utilizes the information to further train the ML model (i.e., deletion program 132 identifies the content as a password). Further in the embodiment, NLP is a subfield of linguistics, computer science, information engineering, and artificial intelligence concerned with the interactions between computers and human (natural) languages, in particular how to program computers to process and analyze large amounts of natural language data. Further yet in the embodiment, NLC classifies text into custom categories using cognitive computing techniques. Text classification, as performed by NLC, is foundational for NLP and ML and is useful for differentiating known words from strings of characters. According to an embodiment of the present invention, deletion program 132 analyzes the content the user of client device 120 saved to the clipboard via ML, NLP, and NLC. In the embodiment, deletion program 132 does not save the content at any point during the analysis. For example, the program on the laptop analyzes the password “6x9t4W7*m#5v2@lycDleP#9h$0oO@vz” which Emily copied to the computer clipboard; in the example, the program concludes, via the analysis, that the content is a string of random letters (both upper case and lower case), numbers, and characters which is typical construction of a complex password.

In an embodiment of the present invention, deletion program 132 analyzes context (step 210). In other words, deletion program 132 analyzes the current context of the user at the time the user saves content to the clipboard. According to an embodiment, deletion program 132 determines the current day and time the user saves the content to the clipboard as well as the applications, programs, etc. that the user is interacting with when the user saves the content. In the embodiment, deletion program 132 can identify patterns of the user as a part of analyzing the context of the user which allows deletion program 132 to “learn” when the user copies/pastes a password. In a first example, if the user opens an e-mail application for the first time at 7:45 AM on a workday, that context might indicate that a random string of characters is a password. However, if the same user is utilizing the e-mail application at 11:00 AM (after accessing the e-mail application at 7:45 AM), the context might indicate that a random string of characters is not a password. In a second example, if the user logs into a social media account during a lunchbreak each workday, copying and pasting a content to do so, the context might indicate that the content is a password. However, if the user is randomly logging into an application at 2:30 PM during a workday, the context may not indicate that the content is a password. In an embodiment, deletion program 132 analyzes the current context of the user when the user of client device 120 saves content to the clipboard. For example, the program on the laptop computer used by Emily determines that it is 12:00 PM on Thursday when Emily saves the content “6x9t4W7*m#5v2@lycDleP#9h$0oO@vz” to the clipboard of the laptop.

According to an embodiment of the present invention, deletion program 132 determines whether the content saved to the clipboard is a password (decision step 212). In other words, responsive to analyzing the content saved to the clipboard and the context of the user at the time the user saved the content to the clipboard, deletion program 132 determines whether the content is a password. In an embodiment, deletion program 132 uses the results of the ML, NLP, and NLC analysis of the content as well as the analysis of the context of the user to make the determination. In one embodiment (decision step 212, NO branch), deletion program 132 determines that the content saved to the clipboard is not a password; therefore, deletion program 132 proceeds to step 216 to store the information. In the embodiment (decision step 212, YES branch), deletion program 132 determines that the content saved to the clipboard is a password; therefore, deletion program 132 proceeds to step 214 to execute a delete action of the password.

In an embodiment, deletion program 132 executes delete action (step 214). In other words, responsive to determining that the content saved to the clipboard is a password, deletion program 132 executes a delete action of the password. In a first embodiment, the delete action taken by deletion program 132 is to delete the content, determined to be a password, stored to the clipboard after the user pastes said content a single time. According to an embodiment of the present invention, deletion program 132 executes a delete action over network 110 on the content saved to the clipboard by a user of client device 120. For example, the program on the laptop deletes the content “6x9t4W7*m#5v2@lycDleP#9h$0O@vz” (which was determined to be a password based on the content and context analysis) from the clipboard of the laptop after Emily pastes said content to access the bank account.

In a second embodiment of the present invention, a delete action taken by deletion program 132 is to delete the content from the clipboard after the content is pasted by the user “n” times, where “n” is a number greater than one. In the second embodiment, “n” is determined by one of (i) the user or (ii) by deletion program 132 based on the determined context (e.g., if the context indicates the password is used for a personal or sensitive context, “n” is a low number but if the context indicates the password is not used for a personal or sensitive context, “n” is a higher number relative to the personal or sensitive context “n”).

In a third embodiment of the present invention, a delete action taken by deletion program 132 is to delete the content from the clipboard after a time period has passed. In the third embodiment, the time period is determined by one of (i) the user or (ii) by deletion program 132 based on the determined context as described above.

In a fourth embodiment of the present invention, a delete action taken by deletion program 132 is to delete the content from the clipboard once deletion program 132 determines that the content has been used successfully by the user (e.g., the user has gained access to a password protected application). In the fourth embodiment, deletion program 132 determines that the user is utilizing the password protected application and then deletes the content from the clipboard.

In a fifth embodiment of the present invention, a delete action taken by deletion program 132 is to prompt the user to delete the password. In the fifth embodiment, deletion program 132 can prompt the user to delete the password (i) after a single paste command, (ii) after “n” number of paste commands, (iii) after a time period has passed, and (iv) after the user begins utilizing the password protected application.

In a sixth embodiment of the present invention, a delete action taken by deletion program 132 is to automatically delete the password. In the sixth embodiment, if a user copies the password for accessing a first application but changes to a second application prior to pasting the copied password, deletion program 132 can identify that the copied password is not associated with the second application and dynamically delete the copied password.

According to an embodiment of the present invention, deletion program 132 stores information (step 216). In other words, deletion program 132 stores the information related to the content saved to the clipboard (without saving the actual content itself). In an embodiment, the information stored by deletion program 132 includes, but is not limited to, the ML/NLP/NLC analysis of the content, the context of the user for when the content was saved, and the pattern of the content (e.g., length, characters used, numbers used, etc.). In the embodiment, deletion program 132 utilizes the stored information in future analyses and determinations to aid the determination of whether a content is a password. According to an embodiment of the present invention, deletion program 132 stores the information to server device 130. According to another embodiment, deletion program 132 stores the information to client device 120. According to yet another embodiment, deletion program 132 stores the information to any available memory in computing environment 100 (not shown in FIG. 1) that is accessible by deletion program 132 over network 110. In an embodiment, deletion program 132 stores information to server device 130. For example, the program on the laptop used by Emily stores the following information to a local memory on the laptop: the analysis of the content “6x9t4W7*m#5v2@lycDleP#9h$0oO@vz”, the context of the computer use of Emily when Emily saved said content to the clipboard, and the pattern of said content.

FIG. 3 depicts computer system 300, which is an example of a system that includes deletion program 132. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method, the method comprising:
receiving, by one or more compute processors, an indication of a user saving a content to a clipboard of a computing device;
determining, by one or more computer processors, whether the saved content is a password based on an analysis of the saved content and a context of actions being performed by the user; and
responsive to determining that the saved content is a password, executing, by one or more computer processors, at least one delete action of a group of delete actions.

2. The method of claim 1, wherein the step of determining, by one or more computer processors, whether the saved content is a password based on the analysis of the saved content and the context of actions being performed by the user, comprises:
analyzing, by one or more computer processors, the saved content using machine learning, natural language processing, and natural language classification to determine a type of content;
analyzing, by one or more computer processors, the context of actions being performed by the user by determining a current day, a current time, and a current application being utilized by the user; and
analyzing, by one or more computer processors, the analysis of the saved content and the analysis of the context of actions being performed by the user to determine whether the saved content is a password.

3. The method of claim 2, wherein the type of content is selected from the group consisting of an existing word, more than one existing words, a part of a sentence, an entire sentence, a website uniform locator, a picture, and a random string of characters of varying length that meet standard password requirements.

4. The method of claim 1, further comprising:
receiving, by one or more computer processors, an acknowledgement from the user of an opt-in for a clipboard deletion program; and
responsive to receiving the acknowledgement, analyzing, by one or more computer processors, one or more interactions between the user and the computing device.

5. The method of claim 4, wherein the step of analyzing, by one or more computer processors, one or more interactions between the user and the computing device, comprises:
determining, by one or more computer processors, actions being performed by the user utilizing the computing device;
determining, by one or more computer processors, interactions of the user utilizing the computing device;
determining, by one or more computer processors, a day or multiple days associated with the determined actions and interactions;
determining, by one or more compute processors, a time or multiple times associated with the determined day or multiple days associated with the determined actions and interactions; and
determining, by one or more computer processors, patterns of the user which require the user to utilize a password based on the determined actions, interactions, days, and times associated with the determined actions and interactions.

6. The method of claim 1, wherein the at least one delete action of a group of delete actions is selected from the group consisting of deleting the content, deleting the content after “n” pastes of the content by the user, deleting the content after a time period has passed, deleting the content after said content is successfully used, prompting the user to delete the content, and deleting the content after recognizing that the content is not associated with an application.

7. The method of claim 6, wherein:
“n” is determined by one of the user or a program; and
the time period is determined by one of the user or the program.

8. A computer program product, the computer program product comprising:
one or more computer readable storage media; and
program instructions stored on the one or more computer readable storage media, the program instructions comprising:
program instructions to receive an indication of a user saving a content to a clipboard of a computing device;
program instructions to determine whether the saved content is a password based on an analysis of the saved content and a context of actions being performed by the user; and
responsive to determining that the saved content is a password, program instructions to execute at least one delete action of a group of delete actions.

9. The computer program product of claim 8, wherein the program instructions to determine whether the saved content is a password based on an analysis of the saved content and a context of actions being performed by the user, comprise:
program instructions to analyze the saved content using machine learning, natural language processing, and natural language classification to determine a type of content;
program instructions to analyze the context of actions being performed by the user by determining a current day, a current time, and a current application being utilized by the user; and
program instructions to analyze the analysis of the saved content and the analysis of the context of actions being performed by the user to determine whether the saved content is a password.

10. The computer program product of claim 9, wherein the type of content is selected from the group consisting of an existing word, more than one existing words, a part of a sentence, an entire sentence, a web site uniform locator, a picture, and a random string of characters of varying length that meet standard password requirements.

11. The computer program product of claim 8, further comprising program instructions stored on the one or more computer readable storage media, to:
receive an acknowledgement from the user of an opt-in for a clipboard deletion program; and
responsive to receiving the acknowledgement, analyze one or more interactions between the user and the computing device.

12. The computer program product of claim 11, wherein the program instructions to analyze one or more interactions between the user and the computing device, comprise:
program instructions to determine actions being performed by the user utilizing the computing device;
program instructions to determine interactions of the user utilizing the computing device;
program instructions to determine a day or multiple days associated with the determined actions and interactions;
program instructions to determine a time or multiple times associated with the determined day or multiple days associated with the determined actions and interactions; and
program instructions to determine patterns of the user which require the user to utilize a password based on the determined actions, interactions, days, and times associated with the determined actions and interactions.

13. The computer program product of claim 8, wherein the at least one delete action of a group of delete actions is selected from the group consisting of deleting the content, deleting the content after “n” pastes of the content by the user, deleting the content after a time period has passed, deleting the content after said content is successfully used, prompting the user to delete the content, and deleting the content after recognizing that the content is not associated with an application.

14. The computer program product of claim 13, wherein:
“n” is determined by one of the user or a program; and
the time period is determined by one of the user or the program.

15. A computer system, the computer system comprising:
one or more computer processors;
one or more computer readable storage media; and
program instructions stored on the one or more computer readable storage media for execution by at least one of the one or more computer processors, the program instructions comprising:
program instructions to receive an indication of a user saving a content to a clipboard of a computing device;
program instructions to determine whether the saved content is a password based on an analysis of the saved content and a context of actions being performed by the user; and
responsive to determining that the saved content is a password, program instructions to execute at least one delete action of a group of delete actions.

16. The computer system of claim 15, wherein the program instructions to determine whether the saved content is a password based on an analysis of the saved content and a context of actions being performed by the user, comprise:
program instructions to analyze the saved content using machine learning, natural language processing, and natural language classification to determine a type of content;
program instructions to analyze the context of actions being performed by the user by determining a current day, a current time, and a current application being utilized by the user; and
program instructions to analyze the analysis of the saved content and the analysis of the context of actions being performed by the user to determine whether the saved content is a password.

17. The computer system of claim 16, wherein the type of content is selected from the group consisting of an existing word, more than one existing words, a part of a sentence, an entire sentence, a web site uniform locator, a picture, and a random string of characters of varying length that meet standard password requirements.

18. The computer system of claim 15, further comprising program instructions stored on the one or more computer readable storage media for execution by at least one of the one or more computer processors, to:
receive an acknowledgement from the user of an opt-in for a clipboard deletion program; and
responsive to receiving the acknowledgement, analyze one or more interactions between the user and the computing device.

19. The computer system of claim 18, wherein the program instructions to analyze one or more interactions between the user and the computing device, comprise:
program instructions to determine actions being performed by the user utilizing the computing device;
program instructions to determine interactions of the user utilizing the computing device;
program instructions to determine a day or multiple days associated with the determined actions and interactions;
program instructions to determine a time or multiple times associated with the determined day or multiple days associated with the determined actions and interactions; and
program instructions to determine patterns of the user which require the user to utilize a password based on the determined actions, interactions, days, and times associated with the determined actions and interactions.

20. The computer system of claim 15, wherein the at least one delete action of a group of delete actions is selected from the group consisting of deleting the content, deleting the content after “n” pastes of the content by the user, deleting the content after a time period has passed, deleting the content after said content is successfully used, and prompting the user to delete the content.
